(19) United States
(12) Patent Application Publication
(10) Pub. No.: US 2005/0242755 A1
(43) Pub. Date: Nov. 3, 2005

(54) Focus voltage control arrangement with ultor voltage tracking

(76) Inventor: John Barrett George, Carmel, IN (US)

Correspondence Address: THOMSON LICENSING INC., PATENT OPERATIONS, PO BOX 5312, PRINCETON, NJ, 08543-5312, US

(21) Appl. No.: 10/511,642

(22) PCT Filed: Apr. 21, 2003
(86) PCT No.: PCT/US03/12177

§ 371 Date: Oct. 18, 2004

Related U.S. Application Data
(60) Provisional application No. 60/374,280, filed on Apr. 19, 2002.

(51) Int. Cl. G09G 1/04

(52) U.S. Cl. 315/382.1; 315/382

(57) ABSTRACT

A video display apparatus includes a cathode ray tube having an ultor terminal for developing an ultor voltage at the ultor terminal to produce a beam current. The ultor voltage has voltage fluctuations in a presence of changes in the beam. A resistive voltage divider is coupled to a source of a first high voltage and to a focus terminal of the cathode ray tube for producing at the focus terminal a second high voltage including voltage fluctuations. The voltage fluctuations are indicative of the voltage fluctuations of the ultor voltage to provide for focus voltage tracking. An amplifier responsive to a periodic correction signal is capacitively coupled via a capacitor having a value of 33 picofarad to the focus terminal. A dynamic focus voltage that varies, in accordance with a variation of a beam landing location, is produced at the focus terminals.

This application claims the benefit of the priority date of U.S. Provisional patent application Ser. No. 60/374,280, filed Apr. 19, 2002.

### FIELD OF THE INVENTION

This invention relates to powering of kinescopes, and more particularly to focus tracking in the presence of ultor voltage variation.

### BACKGROUND OF THE INVENTION

Video displays, such as are used for television viewing and computer operation, often use kinescopes, picture tubes, or cathode ray tubes (CRTs) as the display device. A picture tube is a vacuum tube which has a phosphorescent display screen and control terminals for directing a focussed electron beam toward the screen to generate the desired image. In general, a picture tube requires a relatively high anode or “ultor” voltage to accelerate the electron beam toward the screen, a cathode and a grid which coact for modulating the intensity of the electron beam in accordance with the image to be generated, and a focus electrode to which a focus voltage is applied to cause the electron beam to be focussed at the screen. In addition, a picture tube is associated with a deflection arrangement for deflecting the electron beam both vertically and horizontally. The ultor or anode voltage of the picture tube is often regulated in order to reduce voltage changes attributable to interaction between the internal impedance of the ultor voltage source and the varying cathode or beam current required to generate an image. “Static” focus voltage is applied to the focus terminal of the picture tube in order to focus the electron beam at a given location, such as the center of the screen. It is well understood that the value of the “static” focus voltage is desirably a fixed proportion of the ultor voltage. Dynamic focus control is often provided for adjusting the value of the focus voltage applied to the picture tube in accordance with the position of the electron beam, in order to keep the electron beam focussed on the screen notwithstanding the changing length of the electron beam path attributable to deflection.

A high voltage component of the focus voltage may be provided from the same high voltage transformer that generates the ultor or anode voltage. Factory adjustment of the high voltage component of the focus voltage may require the interposition of a direct current voltage divider between the focus voltage terminal of the high voltage transformer and the focus electrode terminal. The voltage divider has a selectable voltage division ratio.

Beam current changes resulting from video loading cause variations or fluctuations of the ultor voltage. It is known to apply a beam current related voltage fluctuation or changes developed at a terminal of the high voltage transformer to the focus electrode for making the focus voltage track the changes in the ultor voltage. If this ratio tracking requirement is not met everywhere in the picture, there will be portions of the picture where the ultor voltage changes with respect to the focus voltage will cause undesirable de-focussing.

It may be desirable to apply the beam current-related voltage fluctuations or changes developed at the focus voltage terminal of the high voltage transformer to the focus electrode using resistors of the aforementioned voltage divider. Avoiding the use of any coupling capacitors for applying the beam current related voltage fluctuations or changes to the focus electrode results, advantageously,in cost reduction. This is so because such capacitors might have to be rated for high voltage operation.

It may be desirable to reduce the total or equivalent capacitive impedance at the focus terminal. This is so because the resistors of the voltage divider having high values in combination with the total capacitive impedance at the focus voltage terminal form a low pass filter for the voltage fluctuations that, undesirably, could degrade focus voltage tracking.

### SUMMARY OF THE INVENTION

A video display apparatus, embodying an inventive feature, includes a cathode ray tube having an ultor terminal for developing an ultor voltage at the ultor terminal to produce a beam current. The ultor voltage has voltage fluctuations in a presence of changes in the beam current. An impedance is coupled to a source of a first high voltage and to a focus terminal of the cathode ray tube for producing at the focus terminal a second high voltage including voltage fluctuations indicative of the voltage fluctuations of the ultor voltage to provide for focus voltage tracking. An amplifier responsive to a periodic correction signal is capacitively coupled to the focus terminal in a manner to add no more than 75 picofarad to a value of an equivalent capacitance developed at the focus terminal for producing a dynamic focus voltage. The dynamic focus voltage varies, in accordance with a variation of a beam landing location.

### BRIEF DESCRIPTION OF THE DRAWINGS

FIG. 1a is a simplified diagram in block and schematic form illustrating inter alia a dynamic focus and high voltage-related focus signal combiner according to an aspect of the invention, and FIG. 1b shows details of the high voltage and focus voltage supply of FIG. 1a;

FIG. 2a is a simplified equivalent diagram of an arrangement according to an aspect of the invention in which three picture tubes are used, and FIG. 2b illustrates another arrangement according to an aspect of the invention;

FIGS. 3a and 3b are frequency plots of the phase and amplitude components, respectively, of the transfer of vertical dynamic focus signals through the circuit of FIG. 2a, and FIGS. 3c and 3d are frequency plots of the phase and amplitude components, respectively, of the transfer of high voltage sag signals through portions of FIG. 2a;

FIGS. 4a and 4b are frequency plots of the phase and amplitude components, respectively, of the transfer of vertical dynamic focus signals through the circit of FIG. 2b, and FIGS. 4c and 4d are frequency plots of the phase and amplitude, respectively, of the transfer of high voltage sag signals through portions of FIG. 2b.

### DESCRIPTION OF THE INVENTION

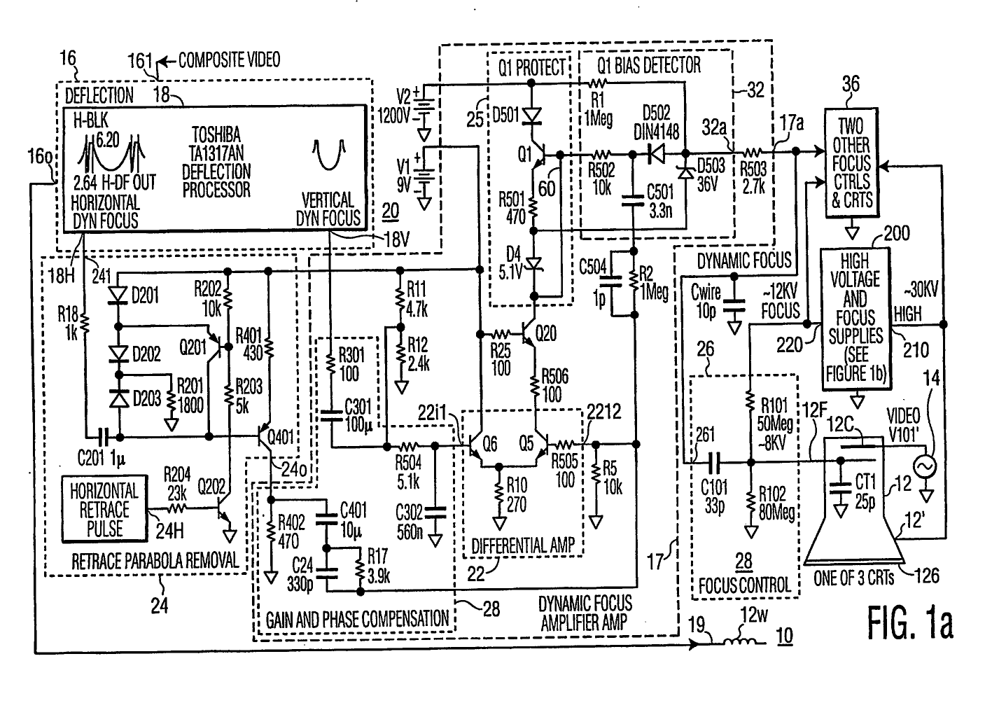

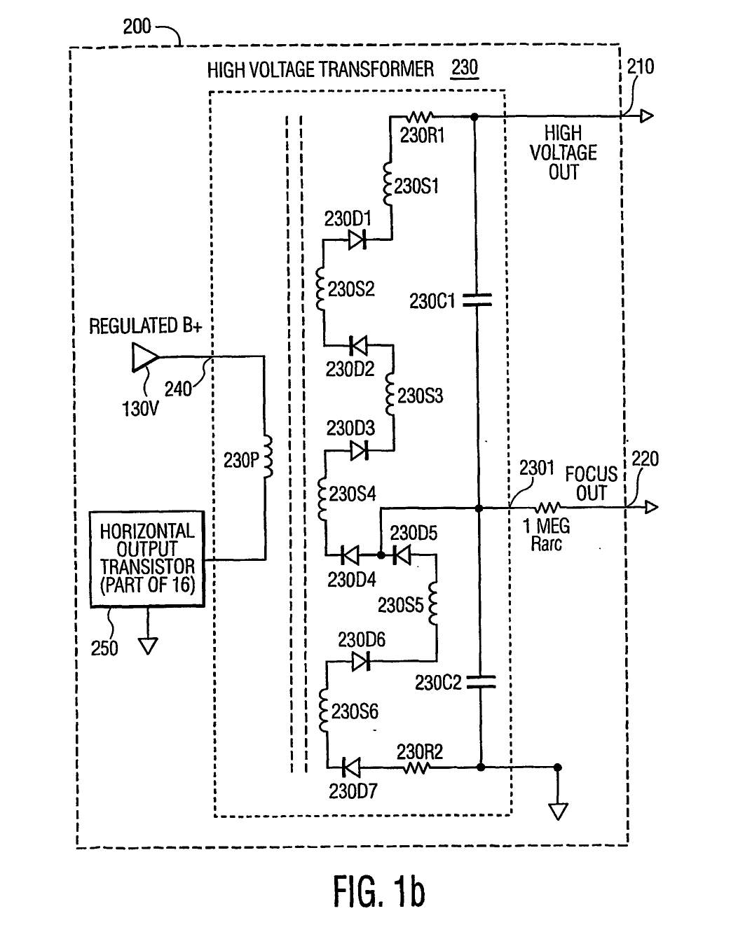

In FIG. 1a, a television apparatus designated generally as 10 includes at lower right a cathode-ray tube (CRT) or kinescope 12 which includes a screen 12S, an ultor or high voltage (anode) terminal 12U, a focus terminal 12F, and a cathode 12C. Cathode 12C of CRT 12 is illustrated as being connected to receive image signal from video source 14. As noted in FIG. 1a, CRT 12 may be one of three similar CRTs, including two in block 36, as might be used, for example, in a projection television arrangement.

The ultor or high voltage terminal 12u of CRT 12 is connected to an ultor or high voltage output terminal 210 of a High Voltage and Focus Supply illustrated as a block 200, which is illustrated in more detail in FIG. 1b. Direct or “static” focus voltage is produced at a focus voltage output terminal 220 of block 200. Focus voltage output terminal 220 is coupled to focus terminal 12F by means of a focus control 26 having a voltage divider 28. Voltage divider 28 includes resistors R101 and R102, with a tap 28t therebetween. That end of resistor R101 of voltage divider 28 which is remote from tap 28t is directly or “galvanically” connected to focus voltage terminal 220. Tap 28t is galvanically connected to focus terminal 12F of CRT 12. Focus control 26 includes an input port 26i to which other focus signals may be applied, and such other focus signals are capacitively coupled to focus terminal 12F by a capacitance C101. Those skilled in the art know that the static focus voltage may be subject to variation attributable to changes in the intensity of the cathode ray or beam of the picture tube 12.

FIG. 1b is a simplified schematic diagram illustrating some details of high voltage and focus supply 200 of FIG. 1a. In FIG. 1b, block 200 includes a high voltage integrated transformer 230 comprising a primary winding 230P and a secondary winding including a plurality of secondary winding sections 230S1, 230S2, 230S3, 230S4, 230S5, and 230S6, serially connected with intermediary rectifier elements designated 230D1, 230D2, 230D3. 230D4, 230D5, 230D6, and 230D7. The internal resistance of windings 230S1, 230S2, 230S3, and 230S4 are represented together as a single resistor 230R1 serially connected between winding 230S1 and high voltage output terminal 210. Similarly, the internal resistance of windings 230S5, 230S6, and 230S7 are represented together as a single resistor 230R2, serially connected between diode 230D7 and ground reference. The focus voltage terminal 230t is connected to a tap point lying between diodes 230D4 and 230D5. The stray or distributed capacitances of those windings and diodes lying above tap 230t are represented by a capacitor 230C1 connected between high voltage terminal 210 and tap terminal 230t. Similarly, the stray of distributed capacitances of those windings and diodes lying below tap 230t are represented by a single capacitor 230C2 connected between tap 230t and ground. A 1 M resistor is provided between tap 230t and focus terminal 220 for arc protection. The primary winding of transformer 230 has one side connected at terminal 240 to a source of regulated B+, and the other end of primary winding 230P is connected to a block 250, representing a horizontal output transistor, which is part of deflection block 16 of FIG. 1a.

Also in FIG. 1a, a deflection arrangement illustrated at upper left as a block 16 receives composite video or at least separated synchronization signals at an input port 16i. Deflection arrangement 16 produces vertical and horizontal deflection signals, which are generated at output terminals, illustrated together as terminal 16o and applied by way of a path 19 to deflection windings, illustrated together as 12W, which is or are associated with the CRT 12, all as known in the art. Deflection arrangement 16 also includes a deflection processor 18, which may be for example a Toshiba TA1317AN deflection processor. Deflection processor 18 produces horizontal dynamic focus signals at an output port 18H, and vertical dynamic focus signals at an output port 18V.

A dynamic focus combining circuit and amplifier, designated generally as 20, includes a differential amplifier 22 including NPN transistors Q5 and Q6, together with a common emitter resistor R10 and arc limiting resistor R505. Vertical dynamic focus signals from terminal 18V of deflection processor 18 are applied to a vertical phase compensating circuit portion of gain and phase compensation block 23. The vertical dynamic focus signals are applied through an arc surge limiting resistor R301, a dc blocking capacitor C301, and phase compensating low-pass components R504 and C302 to a first input port 22i1 of differential amplifier 22. A voltage divider including resistors R11 and R12 provides dc bias for input terminal 22i1 of differential amplifier 22. The low pass filter of vertical phase compensating circuit 23, including resistor 504 and capacitor C302, adds a phase lag and attenuation at frequencies above about 55 Hertz (Hz, formerly known as cycles-per-second or CPS) to those components of vertical dynamic focus signals produced at terminal 18V of deflection processor 18 which are coupled to input 22i1 of differential amplifier 22. Horizontal dynamic focus signals produced at terminal 18H of deflection processor 18 contain, or are associated with, a retrace parabola. The retrace parabola is removed from the horizontal dynamic focus signals in order to limit the bandwidth of the signals so that following slew-rate-limited circuits can respond usefully. The retrace parabola is removed from the horizontal dynamic focus signal by a retrace parabola removal circuit 24, which includes transistors Q201, Q202, and Q401, diodes D201, D202, and D203, capacitor C201, and resistors R16, R201, R202, R203, R204, and R401.

In FIG. 1a, retrace parabola removal circuit 24 includes the series combination of a resistor R16 and a coupling capacitor C201 electrically connected between input port 24i of retrace parabola removal circuit 24 and the base of buffer amplifier transistor Q401, so that in the absence of the remainder of the parabola removal circuit 24, the horizontal-rate dynamic focus signals are coupled from input port 24i to the base of buffer amplifier Q401 without change. A source 24H of horizontal retrace pulses couples positive-going pulses by way of a resistor R201 to the base of a grounded-emitter NPN transistor Q202. Transistor Q202 is nonconductive during the horizontal trace interval, and conductive during the horizontal retrace interval. When transistor Q202 is nonconductive during the horizontal trace interval, PNP transistor Q201 receives no base bias, and is nonconductive. During horizontal retrace, when transistor Q202 is conductive, a voltage divider including resistors R202 and R203 applies a forward bias to the base-emitter junction of transistor Q201, as a result of which transistor Q201 turns ON. The emitter current of transistor Q201 flows through a diode D201 to the +V1 supply voltage, so the emitter of Q201 is held at a voltage which is one semiconductor junction voltage drop (one VBE) below or more negative than the +V1 source. Transistor Q201 also saturates or achieves a state of little collector-to-emitter voltage drop, so the collector of Q201, and therefore the output port 24o, rises to within one VBE of the +V1 source voltage. Thus, the output voltage of retrace parabola removal circuit 24 is set to a fixed magnitude during horizontal retrace, regardless of the magnitude of the horizontal dynamic focus signal applied to input port 24i. A diode D202 and a resistor R201 together form a voltage divider that provides a reference voltage two (2) diode voltage drops (2 VBE) below or more negative than the +V1 voltage source applied to the anode of diode D201. Thus, the cathodes of diodes D202 and D203 are 2 VBE below (more negative than) voltage +V1. Diode D203 together with capacitor C201 clamps the most positive portion of the horizontal dynamic focus waveform to the voltage at the emitter of transistor Q201. The voltage drops across diodes D202 and D203 cancel each other, and tend to minimize changes in the clamped output signal due to temperature-dependent changes in diode VBE. Similarly, diode D201 tends to cancel the VBE drop in transistor Q401 such that the collector current from Q401 is near zero during the most positive portion of the waveform at the base of Q401. This, in turn, tends to clamp to ground the most negative portion of the waveform appearing, in inverted form, across resistor R402, including that portion or part eliminated during the horizontal retrace by switching transistor Q201. The ground clamping action maintains a predictable direct voltage or DC if the horizontal dynamic focus voltage waveform amplitude changes, as for example by bus control of Deflection Processor IC 18.

The horizontal dynamic focus signals with retrace parabola removed are generated at the collector of transistor Q201, and are applied to the base of an inverting amplifier including PNP transistor Q401 and resistors R401 and R402. The amplified horizontal dynamic focus signals (with retrace parabola removed) exit the retrace removal circuit 24 at output 24o and are capacitively coupled from the collector of transistor Q401 by way of the series-parallel combination of an AC gain determining resistor R17, high frequency peaking capacitor C24, and a coupling capacitor C401 to the second input port 22i2 of differential amplifier 22. Differential amplifier 22 produces collector currents from both transistors Q5 and Q6 which are related to the combination of the vertical and horizontal dynamic focus signals. The currents in the collector of transistor Q6 flow to direct voltage supply V1 without any effect. The current flow in the collector of Q5 represents the desired combined dynamic focus signals.

A “dynamic focus amplifier” designated generally as 17 in FIG. 1a includes differential amplifier 22, a Q1 Protection Circuit designated as a block 25, a Q1 Bias Detector circuit 32, feedback components R2 and C504, direct-current (DC) gain and bias determining resistors R5, R11, and R12, vertical gain and phase components R301, C301, R504, and C302, gain determining components R402, C401, C24, and R17, and surge limiting resistors R503 and R25, all of which are discussed below. Terminal 17o is the output port of the dynamic focus amplifier 17.

A transistor Q20 of FIG. 1a is connected in a cascode arrangement with transistor Q5 of differential amplifier 22, with a low-value surge-protection resistor R506 therebetween. Transistor Q20 is a high-voltage transistor with low current gain and high voltage gain. The base of transistor Q20 is connected by a surge protection resistor R25 to direct voltage source V1, so the emitter of transistor Q20 can never rise above voltage V1. This arrangement also maintains constant voltage at the collector of transistor Q5, so there is no voltage change at the collector of Q5 which can be coupled through the Q5 collector-to-base “Miller” capacitance to act as degenerative feedback at higher frequencies, so that transistor Q5 maintains a broad bandwidth.

Transistors Q1 and Q20 and ancillary components together constitute a portion of high-voltage dynamic focus signal amplifier 17 for amplification of the combined dynamic focus signals. The load on the dynamic focus signal amplifier 17 is largely capacitive and equal to the parallel combination of capacitances Cwire, and C101 in series with capacitance CT1 in the CRT(s) which is(are) driven with the amplified dynamic focus signal. This load capacitance is charged through transistor Q1 and discharged through transistor Q20. In FIG. 1a, the collector of NPN transistor Q1 is connected by way of a diode D501 to receive current from supply voltage V2, and its emitter is connected by way of a resistor R501 and a zener diode D4 to the collector of transistor Q20. The base of transistor Q1 is connected by a conductor 60 to the collector of transistor Q20. The base of transistor Q1 is also connected by way of a resistor R502 to the junction of a capacitor C501 and the cathode of a diode D502. The other end of capacitor C501, and the anode of a zener diode D503, are connected to the junction of resistor R501 with the anode of zener diode D4. The anode of diode D502 and the cathode of zener diode D503 are connected by way of resistor R503 to output terminal 17o of dynamic focus amplifier 17. Resistor R2 in parallel with capacitor C504 provides degenerative feedback from a location near the output terminal 17o to input port 22i2 of differential amplifier 22.

In operation of dynamic focus signal amplifier 17 of FIG. 1a, the collector current of transistor Q5 is coupled through the emitter-to-collector path of transistor Q20, diode D4, capacitor C501 and diode D502 to the output 17o of dynamic focus amplifier 17. As a result of the current flow from transistor Q20 to output terminal 17o, capacitor C501 charges. The charging continues until the zener or breakdown voltage of zener diode D503 is reached, after which time D503 conducts so as to hold the voltage across capacitor C501 constant and equal to the zener voltage. A small fraction of the collector current of Q20 flows through resistor R502. During conduction of collector current in transistor Q20, transistor Q1 is maintained OFF or nonconductive because the voltage drop across zener diode D4 reverse-biases the base-emitter junction of transistor Q1.

When collector current in transistor Q20 of FIG. 1a decreases to zero during a portion of the operating cycle of dynamic focus signal amplifier 17, transistor Q1 is turned ON or rendered conductive by discharge of capacitor C501 through resistor R502, the base-emitter junction of transistor Q1, and resistor R501 back to capacitor C501. With Q1 conductive, a substantial Q1 current tends to flow from supply V2 through diode D501, the collector-to-emitter path of transistor Q1, resistor R501, and forward-biased zener diode D503 to the amplifier output terminal 17o. Overcurrent damage to transistor Q1 is prevented by a feedback voltage developed across emitter resistor R501, which limits the collector current to a value established by the zener voltage of diode D4 (minus one base-emitter junction voltage) felt across the emitter resistor R501, so that Q1 operates at constant current when the D4 zener voltage is reached. Capacitor C501 stores sufficient charge to keep Q1 ON during that entire portion of the amplifier cycle during which Q20 is OFF, and also to keep Q1 ON when the collector-to-emitter voltage of Q1 is low. This allows the maximum positive dynamic focus amplifier voltage to closely approach the voltage of supply V2. Resistor R1, connected between the positive V2 supply and output terminal 17o, precharges capacitor C501 at start-up so that the cyclic AC pumping operation can start. Diode D501 in conjunction with resistor R502 tend to protect transistor Q1 from overcurrent through its collector-to-base junction in the event of an internal arc in picture tube 12 between the high voltage or ultor terminal 12U and the focus terminal 12F.

Amplifier 17 may be considered to be a high voltage operational amplifier, at least from the point of view of its output terminal 17o. In this operational amplifier, resistor R2 and capacitor C504 provide feedback from output to input, and resistors R5, R11, and R12 set the direct (DC) operating point. Resistor R17 and capacitor C24 set the dynamic or AC gain for horizontal-rate dynamic focus signals. The alternating or AC gain for vertical-rate dynamic focus signals is set by gain and phase compensation circuit 23 including R504 and C302 together with R2, R5, R17, R402, and C401. Vertical signals flowing from output port 18V of Deflection Processor 18 to non-inverting input port 22i1 of amplifier 17 are conditioned by a low pass filter including R504 and C302. Ignoring the small effects of C401 for purposes of simplicity of explanation, the gain of amplifier 17 for vertical signals applied to input port 22i1 is given by Vgain=R2*(R5+R17+R402)/R5*(R17+R402) where asterisk * represents multiplication. For the component values illustrated in FIG. 1a, the calculated gain is 329.

The amplified combined vertical and horizontal dynamic bias signals produced at output port 32o of Q1 Bias Detector 32 of FIG. 1a may be viewed as being produced by a low-impedance source. The signals are applied through a surge limiting resistor R503 and from port 17o to input port 26i of focus control block 26, and possibly to other corresponding focus controls associated with other picture tubes than picture tube 12, all illustrated together as a block 36. The stray wiring capacitance is designated as C_{wire} and has a value of 10 picofarads (pF), and the capacitance CT1 contributed by the focus electrode of a single picture tube, such as picture tube 12, is about 25 picofarads. A cost saving, according to one aspect of the invention is achieved over regulated high voltage sources by allowing the high voltage to vary in response to beam current. Thus, high voltage source 200 is not regulated, and “sag” or high voltage fluctuations attributable to beam current loading of the high voltage supply 210 are coupled (with attenuation) through voltage divider 28 to focus terminal 12F. No significant portion of the high voltage fluctuations attributable to beam current loading of the high voltage supply 200 is capacitively coupled to focus terminal 12F. Thereby, advantageously, a need for expensive coupling capacitors is avoided.

When sag is coupled from focus voltage source V100 to the tap on focus control 28, frequency-dependent attenuation results from the shunting or paralleling effect of the inherent capacitance CT1 of the focus electrode of the kinescope. This attenuation tends to be increased by the presence of coupling capacitance C101. These two capacitances, together with the equivalent parallel resistance of focus control 28, form a low-pass filter having a cutoff frequency near 90 Hz for focus source 220 “sag” signals. If the cutoff frequency of this filter goes too low, it undesirably attenuates high frequency components of the “sag” signal from focus source 220. According to an aspect of the invention, the coupling of sag from focus voltage source 220 of FIG. 1a to focus terminal 12F is maximized by reducing the value of focus coupling capacitance C101 to be as small as practicable. Unfortunately, reducing the value of capacitance C101 attenuates the available dynamic focus signal applied from amplifier output port 17o to CRT focus terminal 12F. The dynamic focus signals required for best performance at CRT focus terminal 12F are defined by the characteristics of the CRT and are fixed. The dynamic focus signal attenuation in the voltage divider formed by the series arrangement of capacitance C101 and the impedance formed by capacitance CT1 in parallel with R101 and R102 is compensated with increased gain in amplifier 17. However, the available signal output from amplifier 17 available for the compensation is limited by supply V2 of FIG. 1a and by the voltage breakdown ratings of transistors Q1 and Q20. A compromise of these factors or constraints determines the practicable value of capacitance C101.

In carrying out an inventive feature, capacitance C101 has a value selected to add no more than 75 picofarad to a value of an equivalent capacitance, not shown, developed at focus terminal 12F. Advantageously, the selection of such value for capacitance C101 enables the use of sufficiently large resistor R101 to avoid excessive power dissipation.

The value of the equivalent capacitance, not shown, developed at focus terminal 12F, is equal to a sum of the value of capacitance CT1 that is 25 picofarads and the value of the capacitance contributed by capacitace C101. The value of capacitace C101 is selected to be equal to 33 picofarads, that is smaller than the aforementioned limit value of 75 picofarad. Therefore, the value of the equivalent capacitance, not shown, developed at focus terminal 12F is equal to 58 picofarads.

In this way, frequency-dependent attenuation of the voltage fluctuation, not shown, developed at focus terminal 12F resulting from the shunting effect of capacitance C101 is, advantageously, diminished. Thereby, sufficient degree of focus voltage tracking of the ultor voltage fluctuations at terminal 12U is, advantageously, obtained. Whereas, the frequency-dependent attenuation of the dynamic focus voltage coupled from terminal 17o by capacitance C101 is, advantageously, maintained non-excessive with respect to the dynamic range of amplifier 17.

In carrying out another inventive feature, focus voltage tracking at terminal 12F is obtained by using resistor R101 and avoiding the use of coupling capacitors to couple to focus terminal 12F the voltage fluctuations, not shown, attributable to beam current loading of the high voltage supply 200. Avoiding the use of coupling capacitors for applying the beam current related voltage fluctuations or changes to focus electrode 12F results, advantageously, in cost reduction. This is so because such capacitors might have had to be rated for high voltage operation.

As indicated before, in the example of FIG. 1a, capacitance C101 has a value of about 33 picofarads (pF), that is smaller than the aforementioned limit value of 75 picofarad, and the inherent capacitance CT1 has a value of about 25 pF. Such values tend to maintain the cutoff frequency of the low-pass filter formed by capacitances C101 and CT1 with resistors R101 and R102 above frequencies where the attenuation of the filter is excessive for the focus “sag” signals. With the values shown, the cutoff is at about 90 Hz. Therefore, the sag components of the static focus voltage from V100 are coupled to the focus terminal 12F without excessive attenuation. However, the focus voltage at focus terminal 12F needs to respond quickly to the “sag” signal from terminal 220 of supply 200 in order to provide good focus tracking. A filter cutoff frequency above about 400 Hz would be preferred; the 90 Hz cutoff is a compromise forced mainly by the dynamic range limitations of dynamic focus amplifier 17.

The vertical-rate dynamic focus parabola signal has a base frequency of 60 Hz, with harmonics extending higher in frequency. Most of the energy of the vertical-rate dynamic focus signals lies below about 1 kilohertz (kHz). In the 60 Hz to 1 kHz frequency range, it is desirable to have nearly flat amplitude response and a log-plot-linear phase response from the source of the vertical dynamic focus signal to the focus terminal 12F in order to maintain the wave shape. The horizontal base frequency is about 32 kHz (for at least some television displays), with harmonics extending upward in frequency nearly to 1 MHz. In the frequency range extending from about 30 kHz to about 1 megahertz (MHz), the amplitude response of the dynamic focus signals is desirably to have nearly flat amplitude response, with log-plot-linear phase response, also to maintain wave shape. Phase errors in either the vertical or horizontal dynamic focus signals either distort the waveshape, or move the waveform away from the optimum timing position.

According to another aspect of the invention, phase compensation is added before or ahead of the location at which the horizontal and vertical dynamic focus signals are combined, to compensate for unavoidable phase shifts of at least some components of the vertical dynamic focus signals. In the arrangement of FIG. 1a, a capacitor C302 is added between resistor R504 and the base of transistor Q6. The value of capacitor C302 is selected in conjunction with the resistance of R504 so as to define a low pass filter having characteristics which are ideally complementary to the high-pass filter defined by capacitances C101 and CT1 in conjunction with R101 and R102. To the extent that the characteristics of the filters are complementary, the phase shifts introduced into the dynamic focus signals by being coupled through capacitnce C101 and across R101/R102 are compensated by the low pass filter including C302 and R504. The correction of the phase shifts, in turn, tends to avoid defocus of the image on the picture tube.

According to another aspect of the invention, the attenuation of the vertical dynamic focus signals attributable to the low-pass filter including R504 and C302 of FIG. 1a is offset by an increase in the gain of the dynamic focus amplifier/combiner 17. The increase in gain is achieved in any known manner, as for example by decreasing the attenuation of the resistance-capacitance (RC) network consisting of C401, C24, and R17. More particularly, this can be accomplished by an increase in the size of coupling capacitor C401, as to a value of 10 microfarads (:F) as illustrated in FIG. 1a.

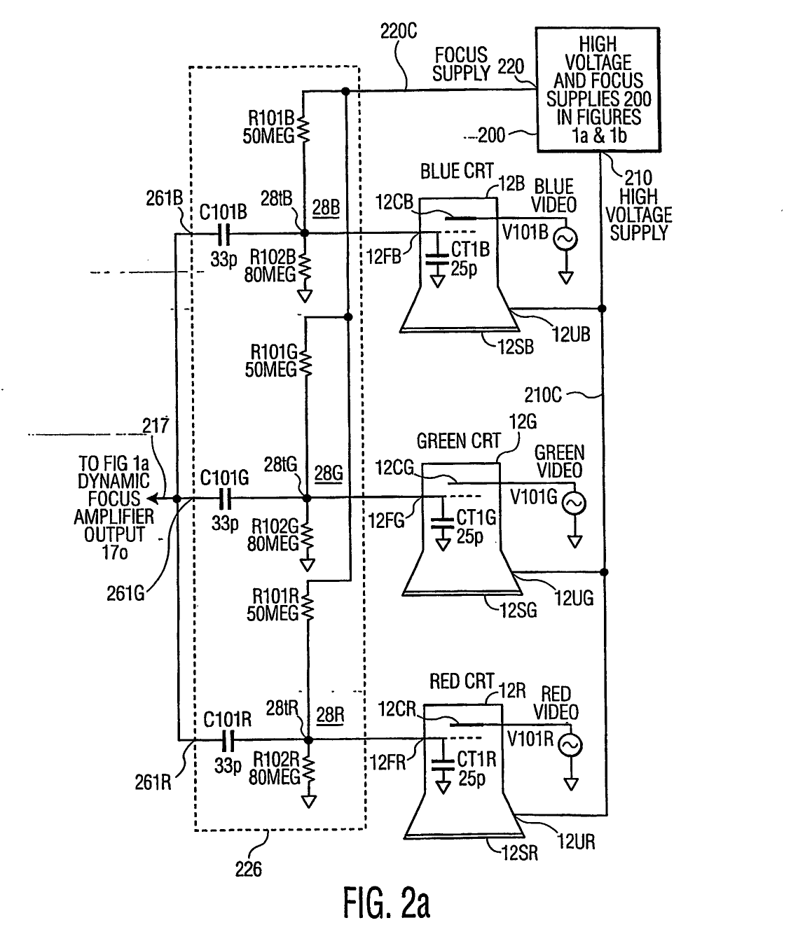

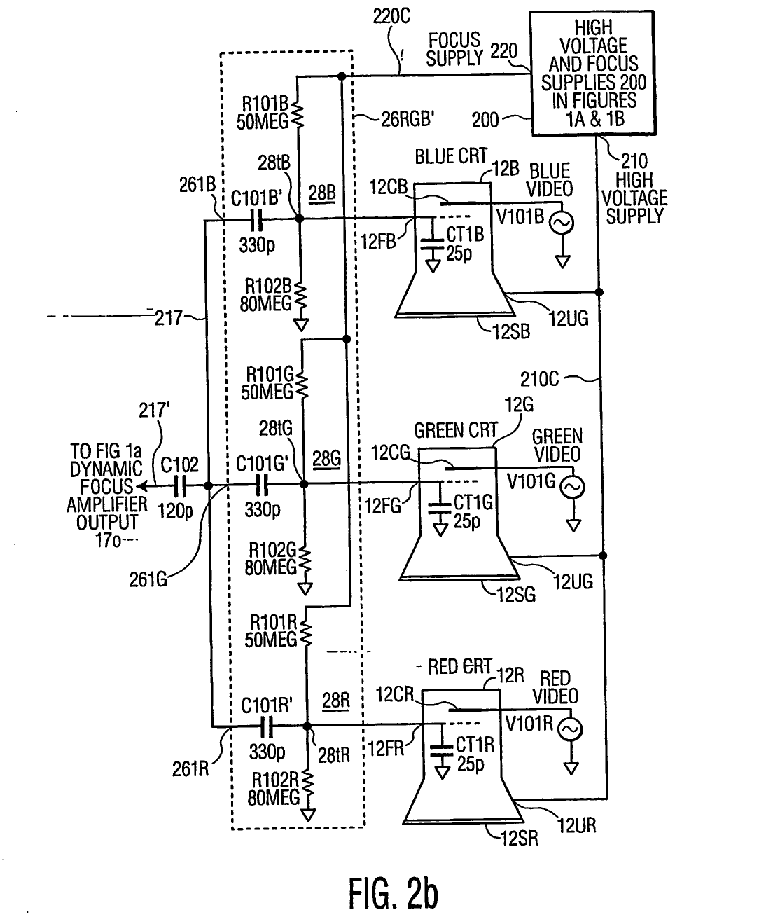

FIG. 2a illustrates the three CRTs of FIG. 1a (that is, CRT 12 and two additional CRTs which are contained in block 36), showing the way dynamic focus signals and sag signals are coupled to the three focus terminals of the three CRTs. In FIG. 2a, the red, green, and blue CRTs are designated 12R, 12G, and 12B, respectively. CRT 12B has a cathode 12CB, screen 12SB, a focus terminal 12FB, and an ultor terminal 12UB. Similarly, green CRT 12G has a cathode 12CG, screen 12SG, a focus terminal 12FG, and an ultor terminal 12UG, and red CRT 12R has a cathode 12CR, screen 12SR, a focus terminal 12FR, and an ultor terminal 12UR. High voltage terminal 210 of High Voltage and Focus supplies 200 is connected by way of a common conductor 210c to the ultor terminals 12UB, 12UG, and 12UR. In FIG. 2a, a source V101B of blue video is connected to blue CRT cathode 12CB, a source V101G of green video is connected to green CRT cathode 12CG, and a source V101R of red video is connected to red CRT cathode 12CR.

The focus terminals of the red, green, and blue CRTs 12R, 12G, and 12B of FIG. 2a are connected to the taps of individual voltage dividers 28R, 28G, and 28B in a common focus control arrangement 226. More particularly, blue focus terminal 12FB is connected to the tap 28TB of a resistive voltage divider 28B including resistors R101B and R102B. Similarly, green focus terminal 12FG is connected to the tap 28TG of a resistive voltage divider 28G including resistors R101G and R102G, and red focus terminal 12FR is connected to the tap 28TR of a resistive voltage divider 28r including resistors R101R and R102R. Focus supply terminal 220 of High Voltage and Focus Supplies block 200 is connected by way of a common conductor 220c to that end of each of resistors R101B, R101G, and R101R which lies remote from the associated tap 28tB, 28tG, and 28tR, respectively. As illustrated in FIG. 2a, the focus electrode or terminal capacitance, CT1B, CT1G or CT1R is 25 pF.

The horizontal and vertical dynamic focus voltages from the output terminal 17o of dynamic focus amplifier 17 of FIG. 1a are applied by way of a conductor 217 of FIG. 2a to input ports 26iB, 26iG, and 26iR of focus control 226 of FIG. 2a. Port 26iB is connected by way of a series capacitor C101B to tap 28tB of voltage divider 28B, port 26iG is connected by way of a series capacitor C101G to tap 28tG of voltage divider 28g, and port 26iR is connected by way of a series capacitor C101R to tap 28tR of voltage divider 28R. The values of capacitors C101R, C101G, and C101B are selected to be 33 pF, as in FIG. 1b.

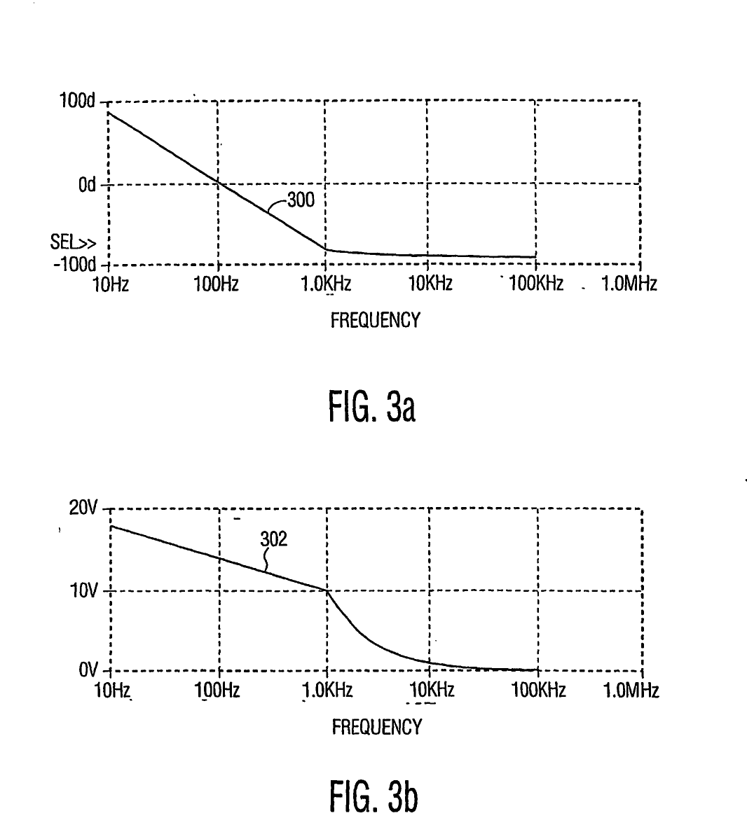

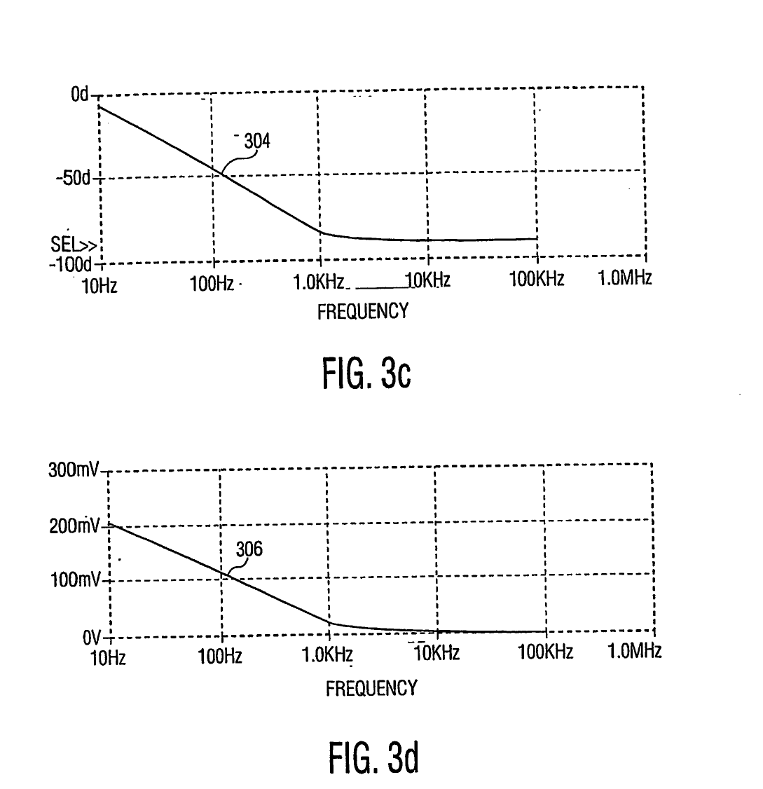

FIG. 3a illustrates a plot 300 of phase (degrees) versus log frequency of the transfer function of a one-volt vertical dynamic focus signal from output 18V of deflection processor 18 of FIG. 1a to any one of the focus terminals 12FR, 12FG, or 12FB of CRTs 12R, 12G, and 12B, respectively, in FIG. 2a. FIG. 3b illustrates a corresponding amplitude plot 302 (volts). FIG. 3c illustrates a plot 304 of phase (degrees) versus log frequency of a one-volt high voltage sag signal from conductor 210c of FIG. 2a to any one of the focus terminals 12FR, 12FG, or 12FB of CRTs 12R, 12G, or 12B, respectively. FIG. 3d illustrates a corresponding amplitude plot 306 (volts).

FIG. 2b is a simplified diagram in block and schematic form similar to FIG. 2a, but differing therefrom in that the values of capacitors C101B, C101G, and C101R are 330 pF instead of 33 pF, and in that a further capacitor C102 having a value of 120 pF is connected in series in conductor 217. The capacitance C102 of 120 pF is equivalent to the capacitance of three 40 pF capacitors in parallel, each in series with one of the 330 pF capacitors C101B′, C101G′, C101R′, so that the actual coupling capacitance to each CRT is about 35 pF, which is of the same order of magnitude as the stray capacitance of the focus terminal of any one of the CRTs. The circuit of FIG. 2b can be used when a focus adjustment assembly 226 is not commercially available with small value coupling capacitors.

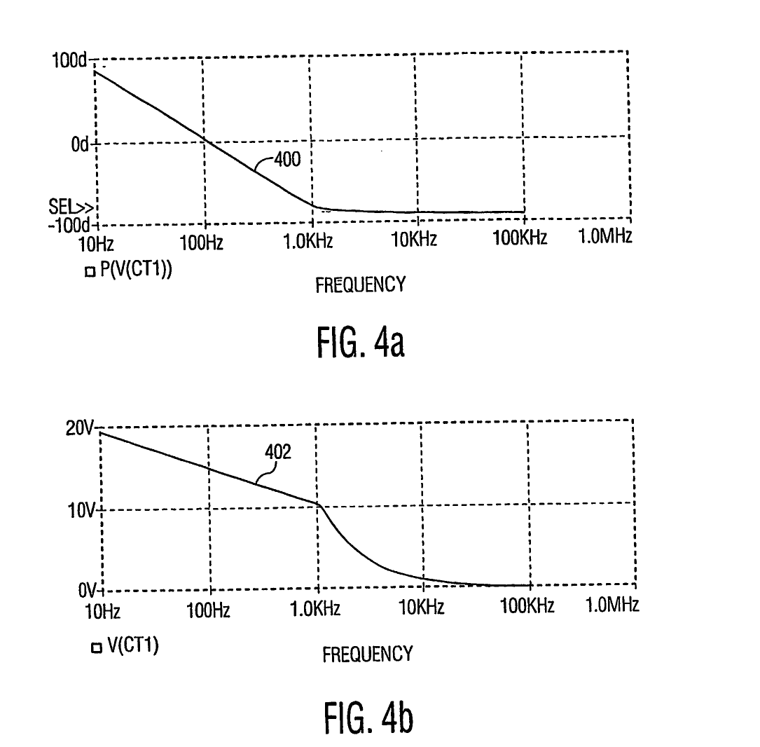

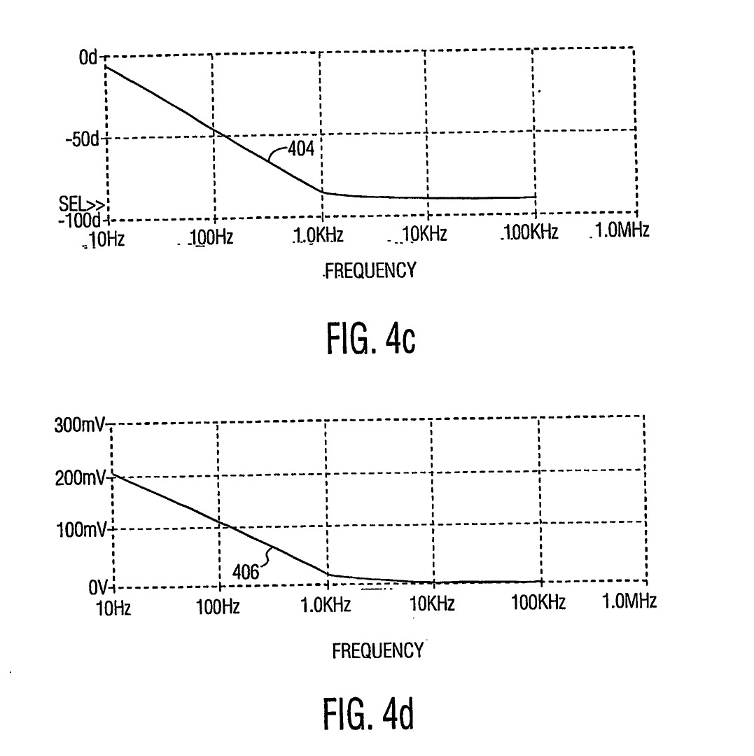

FIG. 4a illustrates a plot 400 of phase (degrees) versus log frequency of the transfer function of a one-volt vertical dynamic focus signal from output 18V of deflection processor 18 of FIG. 1a to any one of the focus terminals 12FR, 12FG, or 12FB of CRTs 12R, 12G, and 12B, respectively, of FIG. 2b. FIG. 4b illustrates a corresponding amplitude plot 402 (volts). FIG. 4c illustrates a plot 404 of phase (degrees) versus log frequency of the transfer function of a one-volt high voltage sag signal from conductor 210c of FIG. 2b to any one of the focus terminals 12FR, 12FG, or 12FB of CRTs 12R, 12G, or 12B, respectively. FIG. 4d illustrates a corresponding amplitude plot 406 (volts). The responses shown in FIGS. 4a through 4d are very similar to the responses shown in FIGS. 3a through 3d, respectively. This similarity shows that the circuits are electrically equivalent and therefore interchangeable.

In FIGS. 3a and 3b or FIGS. 4a and 4b, and between 60 Hz and 1 KHz, the amplitude changes from about 15V to about 10V and the phase from +20 degrees to −90 degrees. There is no phase shift at 103 Hz. Best focus was seen with the dynamic focus terminal slightly voltage phase leading the vertical deflection.

FIGS. 3c and 4c show the amplitude response for a 1-volt change or sag in the HV at conductor 210C, at 60 Hz 130 mV (13%) and at 400 Hz 50 mV (5%). The lowpass filter cutoff, namely where the phase equals −45 E, is shown to be 90 Hz. By comparison, an ideal response for a 1-volt sag at conductor 210C with the divider values shown in FIGS. 1b, 2a, and 2b is given by the product of 33% for the 230t focus tap in FIG. 1b multiplied by 62% for the focus control divider 28 (FIGS. 2a or 2b) equals 200 mV (20%). The ideal filter cutoff should be above 400 Hz to minimize defocusing along the top edge of the high contrast bright picture elements. Since the circuit is not ideal, the tops of white horizontal picture elements with medium contrast will be focus corrected and those with high contrast will be slightly blurred.

1. A video display apparatus, comprising:
a cathode ray tube including an ultor terminal for developing an ultor voltage at said ultor terminal to produce a beam current, said ultor voltage having voltage fluctuations in a presence of changes in said beam current;
a source of a first high voltage;
an impedance coupled to said source of said first high voltage and to a focus terminal of said cathode ray tube for producing at said focus terminal a second high voltage including voltage fluctuations indicative of said voltage fluctuations of said ultor voltage to provide for focus voltage tracking;
a source of a periodic correction signal; and
an amplifier responsive to said periodic correction signal and capacitively coupled to said focus terminal in a manner to add no more than 75 picofarad to a value of an equivalent capacitance developed at said focus terminal for producing at said focus terminal a dynamic focus voltage that varies, in accordance with a variation of a beam landing location.

2. The video display apparatus according to claim 1, further comprising a high voltage winding of a transformer, wherein said voltage fluctuations developed at said focus terminal are coupled in common with said first high voltage via a resistor from a terminal of said transformer in a manner to exclude capacitive coupling.

3. The video display apparatus according to claim 1, wherein said impedance is included in a voltage divider.

4. The video display apparatus according to claim 1, wherein said dynamic focus voltage includes a component at a frequency related to a vertical deflection frequency.

5. The video display apparatus according to claim 1, wherein said dynamic focus voltage includes a component at a frequency related to a horizontal deflection frequency.

6. The video display apparatus according to claim 1, further comprising a capacitor having a first terminal that is coupled to said amplifier and a second terminal that is coupled to said focus terminal for capacitive coupling said amplifier to said focus terminal, wherein the value of said capacitor is selected to be no more than 75 picofarad.

7. The video display apparatus according to claim 6, wherein said impedance is included in a resistive voltage divider having a terminal that is commonly coupled with said capacitor second terminal to said focus trminal.
